(19) United States
(12) Patent Application Publication
(10) Pub. No.: US 2014/0372873 A1
(43) Pub. Date: Dec. 18, 2014

(54) Detecting Main Page Content

(71) Applicants: Dominic Leung, Waterloo (CA); Aaron Kemp, Kitchener (CA)

(72) Inventors: Dominic Leung, Waterloo (CA); Aaron Kemp, Kitchener (CA)

(73) Assignee: Google Inc., Mountain View, CA (US)

(21) Appl. No.: 13/249,510

(22) Filed: Sep. 30, 2011

Related U.S. Application Data
(60) Provisional application No. 61/389,947, filed on Oct. 5, 2010.

(51) Int. Cl. G06F 17/00

(52) U.S. Cl. 715/243

(57) ABSTRACT

Methods, systems, and apparatus, including computer programs encoded on a computer storage medium, for identifying main content of a webpage. In one aspect, a method includes receiving a web document and analyzing the web document to identify sections of the web document and to determine a sequence of the sections. Each section corresponds to a logical portion of a graphical representation of the web document. A particular section is identified as containing main content of the web document based on characteristics of the particular section relative to characteristics of the sections overall. A modified web document is generated based on the identification of the particular section containing the main content.

### CROSS-REFERENCE TO RELATED APPLICATIONS

This application claims the benefit under 35 U.S.C. §119(e) of U.S. Patent Application No. 61/389,947, entitled “Detecting Main Page Content,” filed Oct. 5, 2010, which is incorporated herein by reference in its entirety.

### BACKGROUND

This specification relates to detecting the main content of a webpage or other document.

Webpages are typically designed for display on desktop or laptop computers that have relatively large screens. Such webpages often include multiple sections, e.g., headers, navigational banners, columns, advertisement, etc. Viewing webpages on mobile devices or other devices with small screens can be difficult, as the sections are either presented in such a small format that they are difficult or impossible to read or the user must repeatedly scroll back and forth horizontally as well as up and down vertically to view the content of the page. Moreover, it can be difficult or inconvenient on some mobile devices to navigate through links or other initial content on a webpage. Some webpage developers have deployed webpages specifically designed for mobile devices, but many of these webpages for mobile devices omit significant portions of the content. Other efforts to adapt webpages for presentation on mobile devices include omitting images when retrieving webpages or attempting to identify the main content of a document by searching for a large block of text within the document. In the latter case, for example, the main content may be identified as the first text block that contains some number of words and has some average sentence length. In more detail, flagging a text block as the main content may be based on a set of criteria including: the number of words is less than a maximum number of words or the text block has no element child (e.g., there is no HTML Element nested within the text block HTML Element); the number of words is larger than a minimum number of words; the average sentence is larger than a minimum sentence length, where only non-anchor words (e.g., words within a hyperlink) are counted and anchors (e.g., hyperlinks as a whole) are counted as additional sentences; and the number of words preceding the text block must be between a minimum and a maximum threshold.

### SUMMARY

This specification describes technologies relating to detecting the main content of a page based on an analysis and scoring of the page sections.

In general, one innovative aspect of the subject matter described in this specification can be embodied in methods that include the actions of receiving a web document and analyzing the web document to identify sections of the web document and to determine a sequence of the sections. Each section corresponds to a logical portion of a graphical representation of the web document. A particular section is identified as containing main content of the web document based on characteristics of the particular section relative to characteristics of other or all sections in the web document. A modified web document is generated based on the identification of the particular section containing the main content. Other embodiments of this aspect include corresponding systems, apparatus, and computer programs, configured to perform the actions of the methods, encoded on computer storage devices.

These and other embodiments can each optionally include one or more of the following features. Generating a modified web document includes omitting sections before, in the sequence of the plurality of sections, the particular section containing the main content. The modified web document includes a link adapted for use in requesting at least one of the omitted sections. The modified web document presents at least a subset of the plurality of sections in a sequence corresponding to the identified sequence of the plurality of sections. Analyzing the web document to identify a plurality of sections of the web document includes at least one of identifying a plurality of associated components based on a spatial relationship between the components in a graphical representation of the web document, or identifying boundaries between groups of components based on one of a vertical shift between components in a graphical representation of the web document or a shift between arranging components in a substantially vertical configuration and arranging components in a substantially horizontal configuration. Determining a sequence of the plurality of sections includes analyzing relative vertical and horizontal positions of the plurality sections in a graphical representation of the web document. Identifying a particular section of the plurality of sections as containing the main content of the web document includes determining characteristics associated with each of the plurality of sections, and assigning a score each section based on the characteristics associated with the section. The particular section is identified as containing the main content based on the score for the particular section relative to the score for other sections. The score for each section is based on a comparison of the characteristics associated with the section relative to a combination the characteristics associated with the plurality of sections. One or more of the characteristics associated with at least one of the sections are associated with a positive contribution to the corresponding score and one or more of the characteristics associated with at least one of the sections are associated with a negative contribution to the corresponding score. At least a portion of the characteristics include a number of images in the section, a size of images in the section, a location of a heading for the section, an amount of text in the section, a number of links in the section, a number of words in the section, a text size in the section, a type of content in the section, a location of the section within a graphical representation of the web document, and/or a comparison between two or more of the foregoing characteristics. A plurality of sections containing main content is identified, and a list of sections containing main content is presented in the modified web document. A particular section of the plurality of sections is identified as containing main content of the web document based on information about prior user interactions with the modified web document or an associated modified web document.

In general, another aspect of the subject matter described in this specification can be embodied in methods that include the actions of retrieving a web document and analyzing the web document to identify a plurality of sections of the web document. Each section corresponds to a logical portion of a graphical representation of the web document. A plurality of characteristics for each section in the plurality of sections is identified, and a score for each section is calculated based on the plurality of characteristics. A particular section of the plurality of sections containing main content of the web document is identified. A modified web document is generated based on the particular section. Other embodiments of this aspect include corresponding systems, apparatus, and computer programs, configured to perform the actions of the methods, encoded on computer storage devices.

These and other embodiments can each optionally include one or more of the following features. The score for each section is based, at least in part, on a comparison of the characteristics for the respective section to a combination of characteristics for the plurality of sections. Generating the modified web document includes generating the modified web document omitting sections in the plurality of sections that precede the particular section. Analyzing the web document to identify a plurality of sections of the web document includes segmenting the web document into a plurality of nodes, and identifying associations between nodes in sets of nodes, wherein each set of nodes corresponds to a section. The web document is retrieved in response to receiving a request from a handheld device, and the modified web document is transmitted in response to the request. The score for each section is based on one or more of: a number of items in the section; a size of items in the section; one or more types of items in the section; a location of a heading in the section; a number of links in the section; a comparison of any of the foregoing criteria; a comparison of any of the foregoing characteristics to characteristics for the web document; or a location of the section within the web document. The modified web document includes a subset of the plurality of sections selected according to the score for each section.

In general, another aspect of the subject matter described in this specification can be embodied in systems that include a user device and one or more computers operable to interact with the device, to receive a request for a webpage from the user device, and to analyze the webpage to identify a plurality of sections in the webpage. The one or more computers can further calculate a score for each of the plurality of sections based on characteristics indicative of a significance of the section for the webpage, identify one or more sections containing main content of the webpage, generate a modified webpage based on the one or more sections identified as containing main content of the webpage, and send the modified webpage to the user device.

These and other embodiments can each optionally include one or more of the following features. The one or more computers are further operable to retrieve the webpage from a web server that hosts the webpage. The score for each of the plurality of sections is calculated based on a comparison of characteristics of the section to characteristics of the plurality of sections. The score for each of the plurality of sections is calculated using a scoring algorithm that scores characteristics of the section based on characteristics of the plurality of sections. The characteristics indicative of a significance of the section for the webpage are associated with a likelihood that the section contains main content of the webpage. The characteristics include a number of images in the section, a size of images in the section, a location of a heading for the section, an amount of text in the section, a number of links in the section, a number of words in the section, a text size in the section, a type of content in the section, a location of the section within a graphical representation of the web document, and/or a comparison between two or more of the foregoing characteristics. The one or more computers include a server operable to interact with the user device through a data communication network, and the user device is operable to interact with the server as a client.

Particular embodiments of the subject matter described in this specification can be implemented so as to realize one or more of the following advantages. Browsing the Internet from mobile phones is simplified, made more convenient, less time-consuming, and/or potentially less expensive than presenting a complete webpage. Main content of a webpage can be presented on a user device more quickly and without changing the full content of the webpage. A user can be provided with links or other ways of navigating to the remaining content of the webpage. A modified webpage can be presented on a user device without requiring a sophisticated browser on the user device. The modified webpage can present the most useful content of a webpage immediately, bypassing the navigation links and banners that can add to data cost and require more time to download.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram showing an example architecture of a system for detecting the main content of a webpage based on an analysis and scoring of the webpage's sections.

FIG. 2 is a screenshot of a sample webpage.

FIG. 3 is a screenshot of a sample transcoded webpage illustrating how the webpage from FIG. 2 is reworked.

FIG. 4 is a flow chart showing an example process for identifying sections of a webpage.

FIG. 5 is a flow chart showing an example process for scoring the sections of the webpage and selecting the main content.

Like reference numbers and designations in the various drawings indicate like elements.

### DETAILED DESCRIPTION

This specification describes embodiments of a system that addresses problems that can occur when browsing the Internet using a mobile phone, a feature phone, a personal digital assistant (PDA), or another similar device that typically has a small display and/or a relatively primitive browser. On many of these types of browsers, it can be inconvenient and aggravating for the user to navigate past groups of links Furthermore, data access charges (e.g., the costs charged by cell phone companies per megabyte of data accessed) are expensive in some countries, and networks are slow as well. Thus, one way to improve the user experience is to navigate the user to the most useful content on a webpage immediately. Doing so can bypass the navigation links and banners that have not only an associated data cost but also require more of the user's time. One example category of webpages with many navigational links include various news-related web sites that each contains a banner with links to the different sections of the site, although other types of websites may also include banners or navigational links that may not represent the primary content of the web site.

Embodiments of the present disclosure detect the part of the page that has the main content and advance the user to view the main content directly. The main content of a webpage is defined as the part that is not a navigation block, such as header banners or groups of navigation links. Typically, the main content includes the document's body, or in the example of a news page, the beginning of the first article.

In some implementations, detecting the part of the webpage that has the main content can use the following process. First, each logical section of target webpage is analyzed, and the characteristics of each section are determined. For example, the characteristics can include the number of images and their respective sizes, the location of the first heading and the text size, the total number of text characters and/or images, the number of links, the number of words, and the location of the section on the webpage, to name a few examples.

From the characteristics gathered for each section of the webpage, overall page characteristics can be determined, such as the average link ratio, the average number of words, the total number of items, etc. Moreover, a score can be assigned to each section based on criteria that can affect the score for that section in either a positive or negative way. For example, criteria that contribute to a positive score for the section include a section that contains many large images, a section that contains a heading very close to the beginning, a section that has a low link/text ratio, whether the section has many words compared to the average words per section of the page, and so on. For example, the link/text ratio can help to determine whether a section is primarily navigational or whether the section contains primary content of the webpage, with the latter being a criterion contributing to a higher score. By comparison, criteria that contribute to a negative score for a section in the webpage include the situation in which a section contains very few items and whether the section is only visible if the user scrolls down on the webpage, to name just two examples. In general, scores can be used to rank sections higher if the section appear higher in the webpage or farther to the left. In some embodiments, it may be possible to look for textual or other clues (e.g., words such as “breaking news” or embedded dates) that might indicate how new or important the section is.

Overall page characteristics may include the number of certain components (e.g., words, links, images, etc.), the average size of text or images on the page, and the overall size or length of the page. As an example, for a page that includes a relatively small amount of text, the process of detecting main content may be based more on the number of different links in the section, the arrangement of links (e.g., whether the links are associated with a pattern of navigational buttons or whether the links are mixed into the text), the prominence of images, the location of the section (e.g., whether it is “above the fold”), etc. In another example, for a page that includes a significant amount of text, the process of detecting main content may be based more on the amount of text and its nearness to the top of document. In this case, the location of the text may be scored differently depending on the characteristics of the page. As a result, the scoring algorithm as it is applied to the sections of a webpage can vary depending on the overall page characteristics.

Using the scores determined for all of the sections, the section with the highest score is identified. It is this highest-scoring section, or the section determined most likely to contain the main content, to which the user of a mobile device is navigated. For example, when the webpage is displayed on the user's device, the webpage is automatically scrolled to the section having the main content, as well as formatted to fit within the display of the user's mobile (or other) device.

In some implementations, the ordering of the steps listed above can be altered, although it is generally desirable that both the page's characteristics and the section characteristics be known before scoring is applied. Implementations may not require that the webpage characteristics be determined, but determining webpage characteristics can help make the algorithm more accurate. In some implementations, scoring can be done differently to identify one or more “main content” sections based on the metrics gathered. Furthermore, other dimensions can be used to categorize a section, such as the number of paragraphs, whether the section contains a form, the text size, and so on.

Some implementations can determine that a webpage has multiple “main content” sections, and if so, display multiple main sections at the same time and/or display (e.g., within the user's browser) a list of the main sections identified with a clickable link or other control that will take the user to the corresponding section. Some implementations can re-order the webpage based on the scores, showing highest-scoring sections first, instead of jumping to the section with the highest score.

In some implementations, a section can be determined to be a main content section if its score is above some predetermined threshold and/or within a percentage of the highest scoring section, or if the section's score is sufficiently high enough relative to lower-scoring sections. The predetermined threshold and/or the number of sections designated as main content sections can vary depending on total number of sections in the page.

In some implementations, identifying a particular section as a main content section can be based on information about prior user interactions with the modified webpage. For example, once the modified webpage is created and used by a significant number of users, if the users interactions with the webpage over time indicate that users typically navigate to a different part of the webpage, then that can indicate that the main content section has been incorrectly identified, or that another main content section has gone unidentified. In this case, subsequent generations of the modified web page can identify main content sections differently, potentially reducing the amount of navigating that users need to view the webpage's main content.

Some implementations can produce a modified webpage that includes a subset of the sections selected according to the score for each section. For example, the modified webpage can present just the top three to five highest-scoring sections, while omitting the rest of the sections. The modified webpage can further order (e.g., based on score) the sections that are presented.

Some implementations can expose relative scores of the sections to users, e.g., with highlighting in the margins. For example, sections highlighted in the margin with red can indicate sections that are considered to be main content, with other colors used for different categories of secondary content.

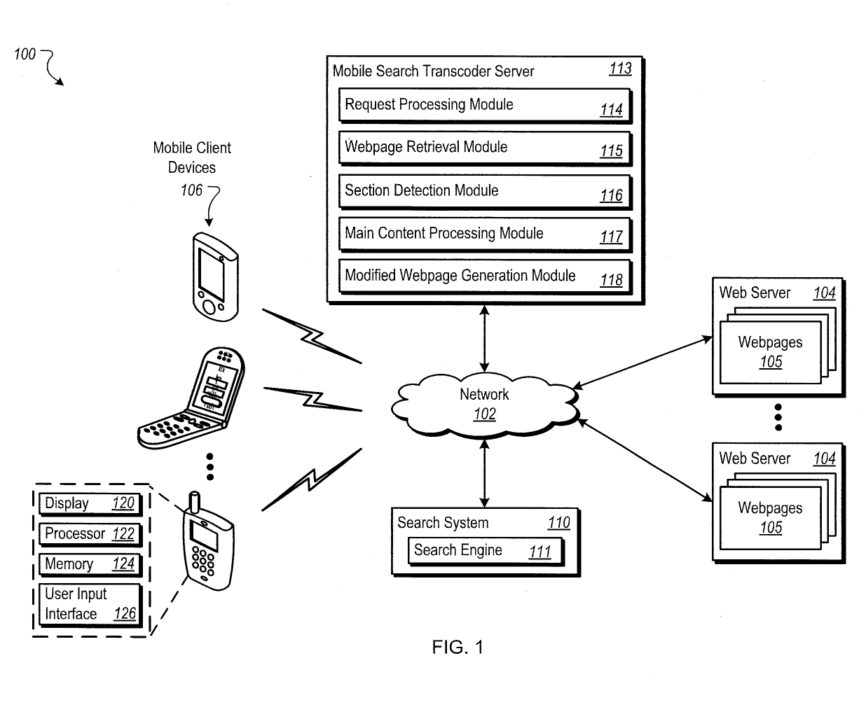

FIG. 1 is a block diagram showing an example architecture of a system 100 for detecting the main content of a webpage based on an analysis and scoring of the webpage's sections. The example system 100 includes a network 102, e.g., a local area network (LAN), wide area network (WAN), the Internet, or any appropriate combination of them. The network 102 connects web servers 104, client devices 106, a search system 110, and a mobile search transcoder server 113. The system 100 may include virtually number of web servers 104 and client devices 106.

In one example of how the system 100 can operate, a user with a client device 106 can request a webpage, such as by typing in the URL of a webpage 105, or by clicking on a link (to a specific webpage 105). For example, the link may be embedded within the search results displayed in the web browser executing on the user's client device 106. The request for the webpage can be transmitted over the network 102. Once the webpage 105 is retrieved from the associated web server 104, the mobile search transcoder server 113 can dynamically analyze the sections of the webpage 105, select the section with main content, generate a modified webpage, and send the modified webpage to requesting client device 106. The modified webpage can be displayed within the user's browser.

Each web server 104 includes one or more web documents or webpages 105 associated with a web site or a domain name, and can be hosted by one or more servers. An example web site is a collection of webpages formatted in hypertext markup language (HTML) that can contain text, images, multimedia content, and programming elements, e.g., scripts. Each web server 104 is maintained by a publisher (or a content provider), e.g., an entity that manages and/or owns the web site. A webpage 105 can be categorized as a web document, which is also a type of resource. A web document (which for brevity will simply be referred to as a document) may, but need not, correspond to a file. A document may be stored in a portion of a file that holds other documents, in a single file dedicated to the document in question, or in multiple coordinated files.

A webpage 105 can include any appropriate data that is capable of being provided by a web server 104 over the network 102 and that is associated with a resource address. Webpages 105 can include HTML pages, word processing documents, and portable document format (PDF) documents, images, video, and feed sources, to name just a few. The webpages 105 can include content, e.g., words, phrases, images and sounds and may include embedded information (e.g., meta information and hyperlinks) and/or embedded instructions (e.g., JavaScript scripts).

A client device 106 is an electronic device that is under control of a user and is capable of requesting and receiving webpages 105 over the network 102. Example client devices 106 include personal computers, mobile communication devices, and other devices that can send and receive data over the network 102. A client device 106 typically includes a user application, e.g., a web browser, to facilitate the sending and receiving of data over the network 102.

Each client device 106 includes a display 120, a processor 122, memory 124 and a user input interface 126. The display 120 is capable of displaying rendered webpages 105 for view by the user of the client device 106. The processor 122 is operable to execute applications, e.g., the web browser and any applications with which the webpages 105 may interact (e.g., for sound, video, etc.). The memory 124 can include read-only memory or a random access memory or both, and can store instructions and data used by the processor 122. The user input interface 126 can include the keys, buttons, touchpad, mouse buttons, etc., of the client device 106 that the user can use, for example, to interact with applications that execute on the client device 106, including web browsers for searching for and displaying webpages 105.

To facilitate searching of webpages 105, the search system 110 can identify the webpages 105 by crawling and indexing the webpages 105 provided on web servers 104. Data about the webpages 105 can be indexed based on the resource to which the data corresponds. The indexed and, optionally, cached copies of the webpages 105 can be stored in an indexed cache. The search system 110 also includes a search engine 111 operable to receive a query for web content and for providing content (e.g., in the form of webpages 105) responsive to the query.

The mobile search transcoder server 113 can be implemented using one or more computers that are connected with one or more client devices 106 over the network 102. When interacting with a client devices 106, for example, the mobile search transcoder server 113 can receive a webpage 105 request, retrieve the webpage 105, analyze sections of the webpage 105, and calculate a score for each section of the webpage 105 based on characteristics that indicate the section's significance (e.g., whether the section is primarily content or is navigational). The mobile search transcoder server 113 can further identify one or more sections containing the main content of the webpage 105, generate a modified webpage based on the one or more sections identified as containing the main content, and send the modified webpage to the user device 106.

Some implementations of the mobile search transcoder server 113 can retrieve the webpage 105 (e.g., requested by the client device 106) from the web server 104 that hosts the webpage 105. When scoring sections of the webpage 105, the calculations can be based on comparing the characteristics of one section to characteristics of other sections. For example, scores for each section can be calculated using a scoring algorithm that scores characteristics of the section differently based on characteristics of the other sections. The scores can be based on characteristics that indicate the likelihood that the section contains main content of the webpage. The characteristics can include the number of images in the section, the size of images in the section, the location of the section's heading, the amount of text in the section, the number of links in the section, the number of words in the section, the text size in the section, the type of content in the section, the location of the section within a graphical representation of the web document, and/or a comparison between two or more of the foregoing characteristics.

To calculate the score for a particular section, a value can be assigned to each characteristic based on a comparison of the characteristic for the section to characteristics of other sections (e.g., to a combination of the characteristic for all of the sections of the webpage). For example, one value may be assigned if the link-to-text ratio for a particular section is above the average link-to-text ratio for all sections, while a different value may be assigned if the link-to-text ratio for a particular section is below the average link-to-text ratio for all sections. Other values may also be assigned for other characteristics. For example, one value may be assigned if the number of words in the particular section is greater than the average number of words per section for all of the sections of the webpage, while a different value may be assigned if the number of words in the particular section is less than the average number of words per section for all of the sections of the webpage. Alternatively or in addition, different values may be assigned based on different characteristics of the overall webpage. For example, one value may be assigned when the number of words in the particular section exceeds the average number of words per section for a webpage having a first total number of words, while a different value may be assigned when the number of words in the particular section exceeds the average number of words per section for a webpage having a different total number of words. The assigned values can be combined (e.g., added) to calculate the score for the particular section. In some implementations, values can be assigned to subsets of the characteristics rather than to individual characteristics. For example, a single value used in calculating the overall score for a particular section can be based on more than one characteristic (e.g., the number of words in the section plus the number of images, links, and other items in the section). Moreover, values can be assigned by comparing a characteristic of a section (e.g., number of words in the section) to a different characteristic of the overall webpage (e.g., an image-to-text ratio for all of the sections of the webpage combined).

In some implementations, the one or more computers that implement the mobile search transcoder server 113 include a server operable to interact with the user device 106 through a data communication network (e.g., the network 102). In some implementations, the user device 106 is operable to interact with the server (e.g., the server on the mobile search transcoder server 113) as a client. Typically, the mobile search transcoder server 113 can be used for a particular request or for all requests from a client device 106 based on detecting that the client device 106 is a mobile device or other device with limited screen space, connectivity, browser capabilities, or processing resources. Alternatively, the mobile search transcoder server 113 can be used for a particular request or for all requests from a client device 106 based on the user of the device 106 explicitly requesting that retrieved pages be processed through the mobile search transcoder server 113 (e.g., by entering search requests or web addresses through a search or web navigation interface associated with the mobile search transcoder server 113).

Some implementations of the mobile search transcoder server 113 can maintain cached versions of modified or transcoded webpages 105. The cached versions can be updated each time that the webpage 105 is updated, meaning that the new version of the webpage 105 is reprocessed by the mobile search transcoder server 113, main content is re-determined, and a transcoded webpage 105 is re-created (and stored in the cache). Cached versions can expire after a pre-determined time threshold (e.g., 5-10 minutes). Using cached versions of transcoded webpages 105 can reduce the overall processing requirements for the mobile search transcoder server 113 while still providing up-to-date transcoded webpages 105.

As shown in FIG. 1, the mobile search transcoder server 113 includes a request processing module 114 for receiving webpage 105 requests from client devices 106, a webpage retrieval module 115 for retrieving the requested webpage 105 from a web server 104, a section detection module 116 for detecting sections on the retrieved webpage 105, a main content processing module 117 for executing an algorithm to detect one or more main content modules, and a modified webpage generation module 118 for generating the modified webpage 105 that starts with the main content section. Other implementations of the mobile search transcoder server 113 can include additional modules not shown in FIG. 1. Functions performed by the mobile search transcoder server 113 can be performed by one module acting alone, or by any combination of modules. In some implementations of the mobile search transcoder server 113, its various modules can be distributed geographically, connected by the network 102, and can reside partially within the search system 110, the client device 106, the web servers 104, or any other components of the system 100.

In one example operation of the mobile search transcoder server 113, the request processing module 114 can receive a request for a particular webpage 105 from the client device 106. The request can be in the form of a URL that the user has typed into his browser, or the user may have clicked on a link either embedded among search results or on another webpage 105. Using the URL of the requested webpage 105, the webpage retrieval module 115 can retrieve the corresponding webpage 105. The retrieval occurs, for example, from the web server 104 that hosts the webpage 105. The retrieved webpage 105 can be one of several webpages 105 available from a particular web server 104, such as the content publisher of a news web site. The webpage 105 can be in the form of HTML code that includes instructions for rendering the content associated with the webpage 105 on a client device 106. In this case, the HTML code can be in a form that would allow the webpage 105 to be displayed on a client device 106 that has a suitably large display as to display the webpage 105 as is. However, a modified webpage 105 (e.g., and HTML code) that is suitable for display on a mobile client device 106 or other device that has a smaller display and/or limited browsing capabilities can be produced, as described above. Further the modified webpage 105 can include markers (e.g., embedded within the HTML code) that position the webpage 105 at the main content (e.g., by generating a new webpage that begins at the main content and includes links to earlier and later content, in case the user is interested in navigating to other content of the web page).

Once the mobile search transcoder server 113 has access to the requested webpage 105, the section detection module 116 can begin to analyze the webpage 105 to detect or identify different sections of the webpage 105. For example, each section can correspond to a different logical portion of the graphical representation of the webpage 105, e.g., the position on the display screen of the client device 106 on which the content appears. The graphical representation of a webpage can include the layout or positioning of one column in relation to another column, one row in relation to another row, spacing between objects in the webpage, indentation of objects (e.g., underneath headings, etc.), and so on.

Once the sections of the webpage 105 are identified, the main content processing module 117 can execute an algorithm to detect one or more main content modules. For example, one step of the algorithm can identify characteristics for each section. In general, the characteristics of a section of the webpage 105 are indicative of the significance of the content of that section of the webpage, and are further associated with the likelihood that the section contains main content of the webpage 105. The characteristics can include, for example, the number of images in the section, the size of the images in the section, the location of a heading for the section, the amount of text in the section (e.g., a count of the number of sentences and/or paragraphs), the number of links in the section, the number of words in the section, the size of the text in the section, whether text in the section has special formatting (e.g., bolding, italics, underlining, etc.), the type of content in the section (e.g., whether the section includes a form, a script, a template, a control, etc.), and the location of the section within a graphical representation of the web document. Some implementations of the main content processing module 117 can include a comparison between two or more of the characteristics.

The main content processing module 117 can further calculate a score for each section of the webpage 105 using the identified characteristics. The calculation can be based on characteristics that are indicative of the significance of the section of the webpage, e.g., whether the section is primarily navigational or whether it contains primary content of the webpage 105. In some implementations, each of the characteristics can be weighted to calculate the score. For example, it may be determined over time that the number of links in a section is a better detector of main content than the size of the text in the section.

In some implementations, the score for each section can based, at least in part, on a comparison of the characteristics for the respective section to a combination of (e.g., an average of, or an amalgamation of) characteristics for the other sections. For example, scoring a section based on the number of links in the section can take into consideration the number of links in the other sections. As an example, a section that has two links can be scored one way if the other sections each have one or zero links, and the section can be scored another way if the other sections have considerably more than two links.

Once the scores for the sections of the webpage 105 are calculated, the main content processing module 117 can identify a particular section as that section that contains the main content of the webpage 105. In some cases, more than one section can be identified as containing the main content, and if so, then the mobile search transcoder server 113 can provide the first of the identified sections, a combination of some of the identified sections, or all of the identified sections to the client device 106, and the provided web page can include one or more ways for the user to navigate to a preferred main content section.

Once the one or more main content sections are identified, the modified webpage generation module 118 can generate a modified webpage 105. In the case in which just one main section has been identified in the webpage 105, the webpage 105 can “start with” the main content section. To accomplish this, the modified webpage generation module 118 can generate HTML code that includes all of the original webpage 105, but displays the main content section first. This means that the main content section is displayed at or near the top of the browser, and just above it the modified webpage can include the preceding content or can include one or more links that the user can select to navigate to content of the webpage 105 that is above the main content section. In the case in which the webpage 105 has multiple main content sections, the modified webpage 105 can include (and display) a list of the main content sections identified. For example, each main content section can be represented and identified using descriptive text and a clickable link. By clicking on the link, for example, the user can navigate to the corresponding section of the modified webpage 105.

In some implementations, the modified webpage generation module 118 can retain the sequence of the sections from the original webpage, but may serialize columns so they are presented one after another, rather than side by side. In other implementations, the modified webpage generation module 118 can reorder the sections according to the scoring that occurred on the sections.

In some implementations, the modified webpage generation module 118 can generate a modified webpage 105 that omits one or more sections that precede the particular main content section. Similarly, one or more sections that follow the particular main content section can also be omitted in certain implementations. The decision to keep or omit a section can be based on that section's score. For example, low-scoring sections thought to be of little or no interest to the user can be omitted. In this way, when the modified webpage 105 is displayed within the user's browser, for example, only high-scoring sections are included, and the user is navigated directly to the one or more main content sections, or links to those sections. Generally, however, it may be preferable to include links or other navigation aids that allow the user to navigate to the omitted sections.

Within the system 100, the decision to provide either the modified webpage 105 or the un-modified webpage 105 can be determined in real time, based on the type of the client device 106 that requested the webpage 105. For example, if the webpage 105 being retrieved is known to be in response to a request from a handheld device (or other small-screen or limited browser device), the mobile search transcoder server 113 can be invoked automatically, and the modified webpage generation module 118 can transmit the modified webpage to the client device 106. However, when requests for webpages 105 are known to originate from client devices 106 that have large displays and generally advanced browsers, the mobile search transcoder server 113 can be bypassed automatically.

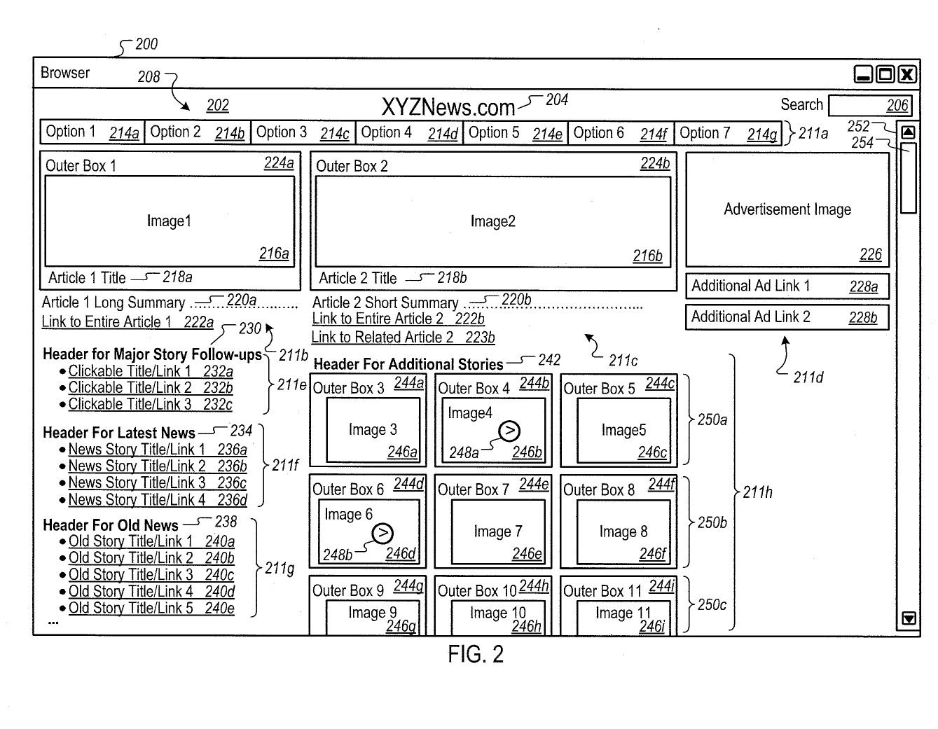

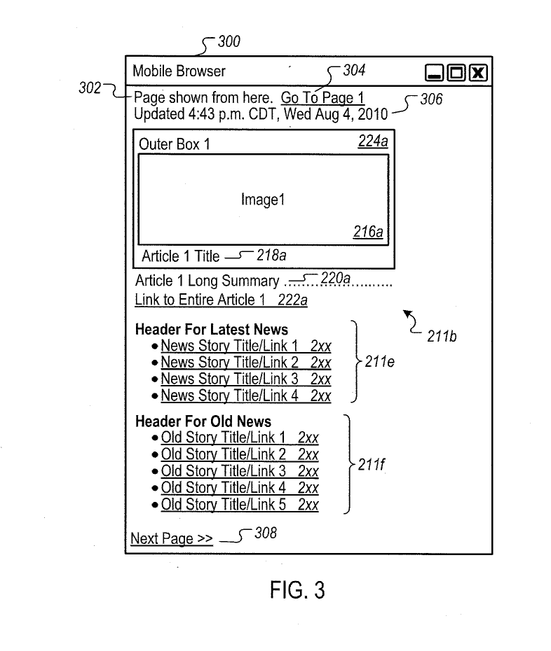

FIG. 2 is a screenshot 200 of a sample webpage 202. The screenshot 200 can represent what a user of a client device 106 sees on his screen upon navigating to the webpage 202. The screenshot 200 can be typical of client devices 106 that have larger screens, e.g., personal computers, laptop computers, and the like. The webpage 202 can be reformatted using the mobile search transcoder server 113 described above (e.g., to generate a webpage 302 that is based on the webpage 202, but reformatted to begin at the main content section, as shown in to FIG. 3). The following description of FIG. 2 includes an explanation of how components of the mobile search transcoder server 113 detect sections of the webpage 202, including the components or nodes that the sections contain.

When the mobile search transcoder server 113 detects sections of the webpage 202, each section can be based on determining a set of visual components (e.g., text, links, images, borders, shapes, or other visual features) that are associated with one another, at least in terms of the manner in which they are presented on the webpage. As an example, a horizontal index header at the top of the webpage 202 (e.g., “XYZNews.com”) can constitute one section, while a vertical left column immediately below the header can be another section. Example vertical columns include a column outlined by a box, or a column that is simply arranged in a column format.

The webpage 202 is an example of a news-related website, as indicated by a webpage title 204 that identifies the webpage 202 as that for “XYZNews.com.” The webpage 202 includes a search box 206, for example, that can be used to search content 208 within the webpage 202. The content 208 includes sections 211a through 211h, each of which includes nodes that are pieces or components of the sections. Nodes can represent or include words, links, boxes, borders, images, controls, and so on. The nodes can include different logical segments of the overall webpage and can be identified, for example, based on the structure of the HTML code that defines the webpage. For example, the HTML code that represents (and contains the application code for rendering) the webpage 202 may contain most or all of the nodes for a section in the same block of HTML code. The HTML code and other factors (e.g., the spatial relationship of the components or nodes of the section) can serve as factors that the system 100 can use to create a modified version of the webpage 202 for display on a mobile client device 106.

Section 211a is a set of options 214a through 214i, labeled “Option 1” through “Option 9.” These options 214a through 214i can be clickable buttons for options such as “Home,” “Video,” etc., each of which is not actual news-related content but can navigate the user to other news stories or other options within the browser. The section detection module 116 may determine that the options 214a through 214i represent a section, or the section 211a, because each option's surrounding box has the same vertical top and bottom coordinates on the screen. Example nodes that can be associated with the option 214a include the box surrounding the option, the option text (e.g., “Option1”), and would include any link inside the option 214a box if one existed.

Section 211b can be the main content section, corresponding to the most breaking news, such as a minutes-old, still-developing story of a breakthrough miracle drug for curing cancer. The section 21 lb can include an image 216a (e.g., an oncologist holding a bottle of the miracle cancer drug), a title 218a (e.g., the title of the cancer drug story), a long summary 220a of the story, and a clickable link 222a that the user of the browser can select or click on to view the entire story, which can pop up in a separate window or other area. The image 216a and title 218a can be contained in an outer box 224a. In some cases, the section detection module 116 may determine that the nodes 216a-224a are all part of the same section because the nodes or components that make up the section are related, either spatially or in how they appear in the HTML code. For example, the long summary 220a, the clickable link 222a and the outer box 224a can each have the same left-side horizontal coordinate on the webpage 202, and the image 216a and the title 218a are contained inside of (or “nested” within) the outer box 224a. The section detection module 116 can use these spatial relationships to determine that the nodes 216a-224a are part of the same section. The section detection module 116 can further limit the section 21 lb to containing just these nodes (and nothing else nearby), for example, because of the white space between section 21 lb and each of sections 211c and 211e. Moreover, section 211b can be determined to be separate from the nodes 214a-214i of section 211 a based on the difference of the spatial relationships of nodes in each section. Specifically, the nodes 214a-214i are a row of nodes, while the nodes that make up section 21 lb are generally a column of nodes, with some nesting of nodes.

Section 211c has a similar structure to that of section 211b, but can represent a different news story than that outlined by section 211b. Section 211c includes an image 216b, a title 218b, a short summary 220b of the story, a clickable link 222b to the entire article, and a link 223b to a related story. The image 216b and the title 218b are contained in an outer box 224b. The section detection module 116 can determine that nodes 216b-224b, and only those nodes, are part of the section 21 lb for similar reasons as section 211b, and further distinguish the nodes 216b-224b as separate from the section 211d.

Section 211d includes an advertisement image node 226 and additional ad links 228a and 228b. In some cases, the section detection module 116 may determine that the ad links 228a and 228b are separate from the advertisement image node 226, except all of the nodes 226, 228a and 228b have edges along the same left and right horizontal coordinates.

Section 211e, 211f and 211g are sections, similar to each other, that each include a title node and clickable link nodes. Specifically, section 211e includes a major story follow-ups header 230 and three clickable title/links 232a-c. Section 211f includes a latest news header 234 and four news story title/links 236a-d. Section 211g includes an old news header 238 and five old story title/links 240a-e. The section detection module 116 can determine that the sections 211e-211g contain the nodes that they do because they may be grouped together in HTML code and/or they are generally arranged in column fashion with indentation used between the title of each section and the clickable links beneath them. Three separate sections are identified here because of the white space in between them.

Section 211h includes an additional stories header 242 and a three-by-three matrix of additional stories represented by outer boxes 244a-244i. Each of the outer boxes 244a-244i provides a control by which the user can access the story. In this case, titles are omitted from the webpage 202 content, but the outer boxes 244a-244i include images 246a-246i, respectively. The images 246a-246i can provide a pictorial representation of the news story that the user can access by clicking on the corresponding control. Generally, clicking anywhere on the images 246a-246i can navigate the user to the corresponding textual story. However, outer boxes 244b and 244d include video play controls 248a and 248b for playing a news video corresponding to the respective stories represented by boxes 244b and 244d, respectively.

In some instances, the section detection module 116 may determine that the outer boxes 244a-244i are arranged in rows 250a-250c. As a result, instead of detecting the single section 211h for all nine outer boxes 244a-244i, the section detection module 116 may instead detect three separate row-oriented sections, with each of the rows 250a-250c being a separate section that each includes three of the boxes 2441-244i. Another possibility is that the section detection module 116 can detect column-oriented sections among the outer boxes 244a-244i.

The browser depicted in the screenshot 200 includes a scroll bar 252 for scrolling through the pages of the sample webpage 202. As shown, a scroll elevator 254 is positioned at the top of the scroll bar 252, indicating that the displayed content of the webpage 202 is positioned at the top or first page. In some implementations, when a modified webpage is created by the system 100, the browser on the mobile client device 106 may or may not include a scroll bar and may instead rely on clickable links for paging forward and backward within the content of the webpage. If a scroll bar 252 is included in the browser on the mobile client device 106, then at the time when the content is positioned at the main content section, the scroll elevator 254 can automatically be set to a position that corresponds to the main content section's relative position within the overall content of the webpage.

FIG. 3 is a screenshot 300 of a sample transcoded webpage 302 illustrating how the webpage 202 from FIG. 2 is reworked. The modified or transcoded webpage 302 omits sections from the webpage 202, including those sections that would otherwise appear before the main content section 211b. However, the sections not appearing on the webpage 202 are accessible using links on the webpage 302.

The transcoded webpage 302 includes a message 302 indicating that the displayed content is just part of the overall webpage, further implying that the webpage content has been positioned at the current location (e.g., at the main content section). To allow the user to navigate to omitted sections, the webpage 302 includes links 304 to one or more previous pages. A timestamp 306 indicates the time that the content was assembled.

Sections 211b, 211e and 211f appear in the screenshot 300 of the webpage 302. The section 21 lb appears first as a result of the main content processing module 117 executing an algorithm to detect the one or more main content modules from the webpage 202. In this case, the section 211b may have been selected, in part, because it included the longest summary (e.g., the long summary 220a) and a relatively low link-to-text ratio. If the main content processing module 117 had instead detected multiple main content sections, the webpage 302 would include clickable main content links to each of the main content sections. In some implementations, the main content links can appear just before the main content section 211b.

The webpage 302 can include one or more links 308 to navigate to subsequent pages the webpage content. Other links and controls not shown in FIG. 3 can also exist. Furthermore, the webpage 302 may or may not include a scroll bar 252, as shown in FIG. 2 but omitted from FIG. 3.

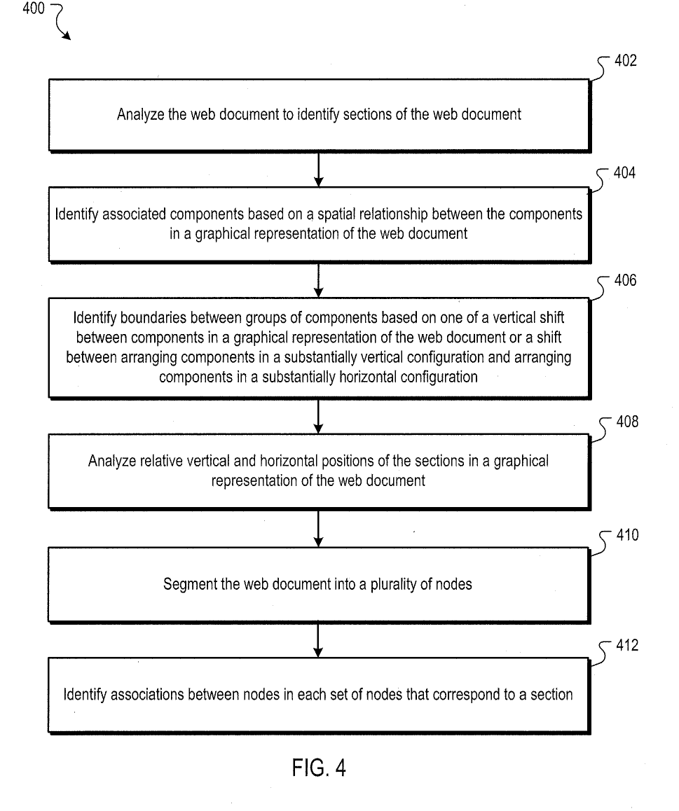

FIG. 4 is a flow chart showing an example process 400 for identifying sections of a webpage. Modules of the mobile search transcoder server 113, for example, can perform the acts of the process 400. The process 400 can be used, for example, to iterate through all the objects on a webpage (e.g., the webpage 202) and to determine whether a new section has started based on the geometry of the nodes, specifically whether there is a vertical jump in the positions of the nodes or if the layout of the webpage has changed from a horizontal to a vertical layout. For example, if objects on the webpage 202 are initially (e.g., at the top of the webpage) laid out in a horizontal manner, but the layout changes to a vertical layout, then the section detection module 116 can mark the transition point as the start of a new section. This is useful for detecting horizontal banners and link groups (e.g., the options 214a-214i) at the beginning of a page. If the current object position is significantly higher (or lower) than the previous element, the section detection module 116 can mark the current element as the start of a new section.

The web document is analyzed to identify sections of the web document (at 402). The web document analyzed can be one of the webpages 105 described with reference to FIG. 1 or the webpage 202 described with reference to FIG. 2. The webpage retrieval module 115 can receive the requested webpage 105 from the web server 104 associated with the content provider for that webpage.

Associated components are identified based on a spatial relationship between the components in a graphical representation of the web document (at 404). The components that are identified can include any of the objects or nodes described above, including words, links, boxes, borders, images, controls, and so on. Example spatial relationships among components include components (e.g., option buttons or boxes) that are arranged in a row and each have the same upper vertical coordinates and lower vertical coordinates. Or in general, spatial relationships can include objects on a webpage that are aligned in some way, such as left-, right-, top-, bottom-, or center-justification. Spatial relationships can also include objects or sections that are inside (or “nested” within) another object or section, e.g., an image inside of a box or a number of subsections within a larger section. The section detection module 116, for example, can determine the spatial relationships determined in this step. The spatial relationships can correspond to what the user sees, such as objects on a webpage that appear to be in the same column, the same row, the same area, or the same group, to a name a few examples.

Boundaries between groups of components can be identified, for example, based on either a vertical shift between components in a graphical representation of the web document or a shift between arranging components in a substantially vertical configuration and arranging components in a substantially horizontal configuration (at 406). For example, referring to FIG. 2, the section detection module 116, while processing the objects of the webpage 202, can first encounter the options 214a-214i and conclude that they comprise a group of a horizontal objects (e.g., the section 211a). When the section detection module 116 continues on, it can encounter another row, in this case the row of objects 224a, 224b and 226 which, in some circumstances can be considered a row of objects. However, only the tops of these objects line up vertically. Thus, the section detection module 116 can instead determine that the format of the webpage 202 has switched from a horizontal configuration (e.g., including the row of options 214a-214i) to a vertical configuration. The configuration is vertical because it includes a column of sections, having sections 211b, 211e, 211f and 211g in the first column, and so on. Space separating groups of components (e.g., the space between the sections 211b and 211e) can, for example, serve as a signal to the section detection module 116 that a boundary between groups of components has been found. In this step, detecting boundaries between “substantially” vertical or horizontal configurations is intended to cover situations in which, for example, a horizontal header includes two rows, such that it could also be viewed as a number of columns of two rows each.

Note that the section detection module 116 can process the objects on a webpage in any appropriate order, including the order that the objects are coded within the HTML code. This order may or may not correspond to a top-to-bottom and left-to-right arrangement of the objects on the webpage.

Relative vertical and horizontal positions of the sections in a graphical representation of the web document are analyzed (at 408). For example, when the section detection module 116 analyzes the graphical representation of the web page 202, the vertical and horizontal positions of the sections 211a-211i can be taken into account relative to each other in determining how the sections are organized.

The web document is segmented into a plurality of nodes (at 410). As an example, the section detection module 116 can examine the HTML code in order to segment the web page 202 into nodes that represent or include words, links, boxes, borders, images, controls, and so on.

Associations between nodes are identified in each set of nodes that correspond to a section (at 412). For example, the section detection module 116 can identify associations among the nodes, e.g., by analyzing the HTML code to determine which nodes correspond to the same component or section.

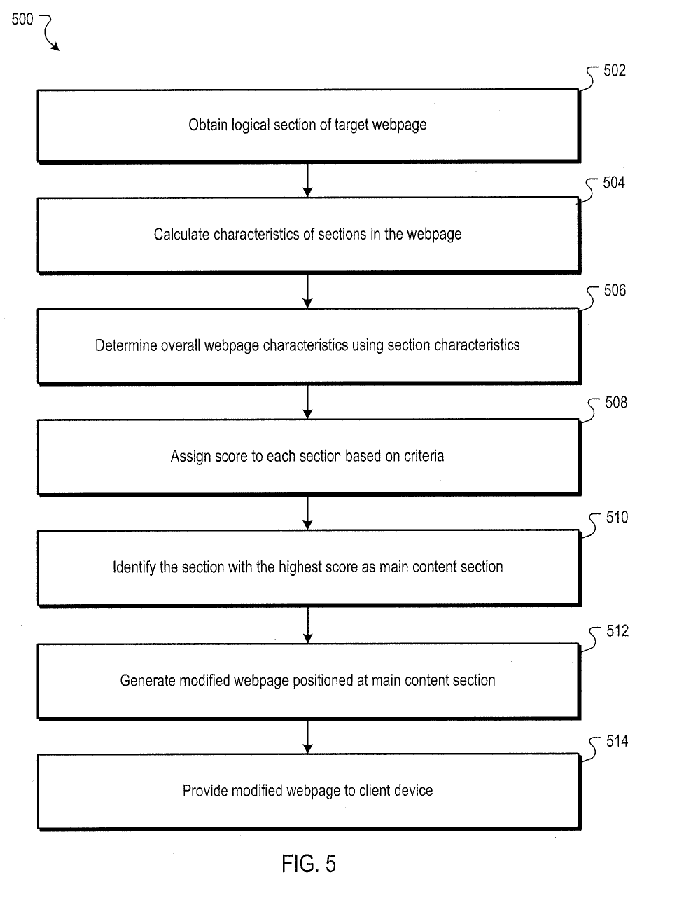

FIG. 5 is a flow chart showing an example process 500 for scoring the sections of the webpage and selecting the main content. Modules of the mobile search transcoder server 113, for example, can perform the acts of the process 500.

A logical section of a target webpage is obtained (at 502). On a news-related webpage (e.g., depicted in FIG. 2), for example, the logical section can include one or all of an image that corresponds to the news story, a title of the news story, a summary of the news story, the whole story itself, a link to the news story, links to related stories, or controls associated with the web content that appears on the page and is related to the story, e.g., controls to play a video of a news clip of the story. For example, in the webpage 202 described with reference to FIG. 2, a logical section of the webpage can be the section 211b. Examples of other logical sections include section 211a and any of the sections 211c through 211h. The section detection module 116, for example, can obtain the logical section of the target webpage after it is retrieved by the webpage retrieval module 115.

The characteristics of the sections in the webpage are calculated (at 504). The characteristics can be a measure of the qualities of the section that can indicate whether the section is likely to be main content of the webpage (e.g., section 211b of the webpage 202), based on the nodes associated with the section. The section detection module 116, for example, can calculate characteristics that include the number of images and their respective sizes, the location of the first heading and the text size, the total number of text characters and/or images, the number of links, the number of words, and the location of the section on the webpage, to name a few examples. A section, e.g., section 211b, that appears after a heading and options, near the top of the webpage (and on the left side), and includes a large image and just a few links can indicate several characteristics that make the section likely to be main content.

Overall webpage characteristics are determined using section characteristics (at 506). The section detection module 116, for example, can use characteristics gathered for each section of the webpage 202 to determine overall page characteristics. Example overall page characteristics include average link ratio for the webpage, the average number of words, the total number of items, etc. Various overall webpage characteristics can be averages of section characteristics, combinations (or amalgams) of section characteristics, totals of section characteristics, and/or any other ways of characterizing the webpage in terms of the characteristics of the sections.

For example, overall page characteristics may include the number of certain components (e.g., words, links, images, etc.), the average size of text or images on the page, and the overall size or length of the page. As an example, for a page that includes a relatively small amount of text, the process of detecting main content may be based more on the number of different links in the section, the arrangement of links (e.g., whether the links are associated with a pattern of navigational buttons or whether the links are mixed into the text), the prominence of images, the location of the section (e.g., whether it is “above the fold”), etc. In another example, for a page that includes a significant amount of text, the process of detecting main content may be based more on the amount of text and its proximity to the top of document. In this case, the text's location may be scored differently depending on the characteristics of the page. As a result, the scoring algorithm as it is applied to the sections of a webpage can vary depending on the overall page characteristics.

A score is assigned to each section based on criteria (at 508). For example, the section detection module 116 can assign a score to each section (e.g., sections 211a-211h of the webpage 202) based on criteria that positively or negatively contribute to the score for that section. The criteria can be based on the characteristics of one or more sections. For example, various characteristics associated with one or more sections can be associated with a positive contribution, and various characteristics associated with one or more sections can be associated with a negative contribution. Criteria that contribute positively to the score, for example, can include situations in which a section contains several large images, a section that contains a heading very close to the beginning, a section that has a low link/text ratio, whether the section has many words compared to the average words per section of the page, and so on. For example, the link/text ratio can help to determine whether a section is primarily navigational or whether the section contains primary content of the webpage, with the latter being a criterion contributing to a higher score. By comparison, criteria that contribute to a negative score for a section in the webpage include the situation in which a section contains very few items and whether the section is only visible if the user scrolls down on the webpage, to name just two examples. In general, scores can be used to rank sections higher if the section appear higher in the webpage or farther to the left.

The section with the highest score is identified as the main content section (at 510). Using the scores determined for all of the sections, the section with the highest score is identified. It is this highest-scoring section, or the section determined most likely to contain the main content, to which the user of a mobile device is navigated. For example, when the webpage is displayed on the user's client device 106, the webpage is automatically generated to begin with the section having the main content, and the webpage is formatted to fit within the display of the user's mobile (or other) device.

Once the main content page is identified, the modified webpage is generated and is further positioned at the main content section (at 512). For example, the modified webpage generation module 118 can generate modified HTML code that includes all of the original webpage 202, but displays the main content section first. Alternatively, the modified HTML code can define the page such that the main content section is displayed at or near the top of the browser, and just above it the modified webpage can include one or more links that the user can select to navigate to content of the webpage 302 that is above the main content section.

The modified webpage is presented to the client device (at 514). The mobile search transcoder server 113, for example, can provide modified webpage 302 to the client device 106. In the case in which the original webpage 202 has multiple main content sections, the modified webpage 302 can include (and display) a list of the main content sections identified. For example, each main content section can be represented and identified using descriptive text and a clickable link. By clicking on the link, for example, the user can navigate to the corresponding section of the modified webpage 302.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. The described techniques could be implemented on a client device, instead of providing an indication of the main content over a network. For example, a native application (e.g., on a smart phone) could identify a point out the main section of a page to the user and/or skip to that section for presentation on the device display. An application could, based on a list of websites that a user is interested in, show the user a customized page containing main content sections of sites in the list (e.g., similar to RSS feeds). In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a web document;
analyzing the web document to identify a plurality of sections of the web document and to determine a sequence of the plurality of sections, wherein each section corresponds to a logical portion of a graphical representation of the web document;
determining scores for individual sections of the plurality of sections, wherein the score for an individual section is determined based on characteristics, comprising at least three members of the group consisting of: a number of items in the section, types of items in the section, a location of a heading in the section, a number of links in the section, a number of words in the section, a font in the section, and a location of the section within a graphical representation of the web document;
identifying a particular section of the plurality of sections as containing highest-ranked content of the web document based on the assigned scores;
generating a modified web document representing the plurality of sections of the web document; and
initiating a display of the modified web document, wherein the modified web document is formatted to begin with the particular section identified as containing the highest-ranked content.

2. The method of claim 1 wherein generating a modified web document includes omitting at least one section before, in the sequence of the plurality of sections, the particular section containing the highest-ranked content.

3. The method of claim 2 wherein the modified web document includes a link adapted for use in requesting at least one of the omitted sections.

4. The method of claim 2 wherein the modified web document presents at least a subset of the plurality of sections in a sequence corresponding to the identified sequence of the plurality of sections.

5. The method of claim 1 wherein analyzing the web document to identify a plurality of sections of the web document includes at least one of:
identifying a plurality of associated components based on a spatial relationship between the components in a graphical representation of the web document; or
identifying boundaries between groups of components based on one of a vertical shift between components in a graphical representation of the web document or a shift between arranging components in a substantially vertical configuration and arranging components in a substantially horizontal configuration.

6. The method of claim 1 wherein determining a sequence of the plurality of sections includes analyzing relative vertical and horizontal positions of the plurality of sections in a graphical representation of the web document.

7. The method of claim 1 wherein identifying a particular section of the plurality of sections as containing the highest-ranked content of the web document includes:
determining characteristics associated with each of the plurality of sections; and
assigning a score to each section based on the characteristics associated with the section, wherein the particular section is identified as containing the highest-ranked content based on the score for the particular section relative to the scores for other sections.

8. The method of claim 7 wherein the score for each section is calculated by combining values assigned to the section, with each value corresponding to one or more characteristics associated with the section and determined based on a comparison of the one or more characteristics associated with the section to one or more characteristics associated with the plurality of sections.

9. The method of claim 7 wherein one or more of the characteristics associated with at least one of the sections are associated with a positive contribution to the corresponding score and one or more of the characteristics associated with at least one of the sections are associated with a negative contribution to the corresponding score.

10. The method of claim 1 wherein the score for an individual section is determined based on characteristics, comprising at least four members of the group, and wherein the group further includes:
a comparison between two or more of the foregoing characteristics and a comparison of any of the foregoing characteristics to characteristics for the web document.

11. The method of claim 1 further comprising:
identifying a plurality of sections containing the highest-ranked content; and
presenting a list of sections containing the highest-ranked content in the modified web document.

12. The method of claim 1 further comprising identifying the particular section of the plurality of sections as containing the highest-ranked content of the web document based, at least in part, on information about prior user interactions with the modified web document or an associated modified web document.

13. A non-transitory computer storage medium encoded with a computer program, the program comprising instructions that when executed by data processing apparatus cause the data processing apparatus to perform operations comprising:
retrieving a web document;
analyzing the web document to identify a plurality of sections of the web document, wherein each section corresponds to a logical portion of a graphical representation of the web document;
identifying a plurality of characteristics for each section in the plurality of sections;
calculating a score for each section based, at least in part, on the characteristics, comprising at least three members of the group consisting of: a number of items in the section, types of items in the section, a location of a heading in the section, a number of links in the section, a number of words in the section, a font in the section, and a location of the section within a graphical representation of the web document;
identifying a particular section of the plurality of sections containing highest-ranked content of the web document based on the scores;
generating a modified web document representing the plurality of sections of the web document; and
wherein the modified web document is formatted to begin with the particular section identified as containing the highest-ranked content.

14. The computer storage medium of claim 12 wherein the score for each section is based, at least in part, on values assigned to characteristics associated with the respective section, with each value corresponding to one or more characteristics of the respective section and determined based on a comparison of the one or more characteristics for the respective section to one or more characteristics for the plurality of sections.

15. The computer storage medium of claim 12 wherein generating the modified web document includes generating the modified web document by omitting sections in the plurality of sections that precede the particular section.

16. The computer storage medium of claim 12 wherein analyzing the web document to identify a plurality of sections of the web document includes:
segmenting the web document into a plurality of nodes; and
identifying associations between nodes in sets of nodes, wherein each set of nodes corresponds to a section.

17. The computer storage medium of claim 12 wherein the web document is retrieved in response to receiving a request from a handheld device, and the instructions cause the data processing apparatus to further perform operations comprising transmitting the modified web document in response to the request.

18. The computer storage medium of claim 12 wherein the score for each section is determined based on characteristics, comprising at least four members of the group, and wherein the group further includes:
a comparison between two or more of the foregoing characteristics and a comparison of any of the foregoing characteristics to characteristics for the web document.

19. The computer storage medium of claim 12 wherein the modified web document includes a subset of the plurality of sections selected according to the respective scores for the sections.

20. A system comprising:
a user device; and
one or more computers operable to interact with the device and to:
receive a request for a webpage from the user device;
analyze the webpage to identify a plurality of sections in the webpage;
calculate a score for each of the plurality of sections, wherein the score is calculated based on characteristics, comprising at least three members of the group consisting of: a number of items in the section, types of items in the section, a location of a heading in the section, a number of links in the section, a number of words in the section, a font in the section, and a location of the section within a graphical representation of the web document;
identify a particular section of the plurality of sections as containing highest-ranked content of the webpage;
generate a modified webpage representing the plurality of sections of the webpage; and
send the modified webpage to the user device;
initiate a display of the modified webpage, wherein the modified webpage is formatted to begin with the particular section-identified as containing the highest-ranked content.

21. The system of claim 20 wherein the one or more computers are further operable to retrieve the webpage from a web server that hosts the webpage.

22. The system of claim 20 wherein the score for each of the plurality of sections is calculated based on values assigned to characteristics associated with the respective section, with each value corresponding to one or more characteristics of the respective section and determined based on a comparison of the one or more characteristics of the section to one or more characteristics of the plurality of sections.

23. The system of claim 20 wherein the score for each of the plurality of sections is calculated using a scoring algorithm that scores characteristics of the section based on characteristics of the plurality of sections.

24. The system of claim 20 wherein the characteristics of the section in the webpage are associated with a likelihood that the section contains the highest-ranked content of the webpage.

25. The system of claim 24 wherein the the score for each section is determined based on characteristics, comprising at least four members of the group, and wherein the group further includes:
a comparison between two or more of the foregoing characteristics and a comparison of any of the foregoing characteristics to characteristics for the web document.

26. The system of claim 20 wherein the one or more computers include a server operable to interact with the user device through a data communication network, and the user device is operable to interact with the server as a client.
